(19) United States
(12) Patent Application Publication
(10) Pub. No.: US 2014/0063444 A1
(43) Pub. Date: Mar. 6, 2014

(54) METHODS AND APPARATUS FOR FORMING A TRANSLATING MULTIFOCAL CONTACT LENS

(71) Applicant: Johnson & Johnson Vision Care, Inc., (US)

(72) Inventors: Christopher Wildsmith, Jacksonville, FL (US); Michael Widman, Jacksonville, FL (US); Jonathan P. Adams, Jacksonville, FL (US)

(73) Assignee: Johnson & Johnson Vision Care, Inc., Jacksonville, FL (US)

(21) Appl. No.: 13/854,578

(22) Filed: Apr. 1, 2013

Related U.S. Application Data
(60) Provisional application No. 61/617,794, filed on Mar. 30, 2012.

(51) Int. Cl. G02C 7/04; B29D 11/00

(52) U.S. Cl. CPC G02C 7/043; G02C 7/048; B29D 11/00057
USPC 351/159.1; 425/162

(57) ABSTRACT

The present invention discloses a translating multifocal contact lens including one or more of multiple Optic Zones, a lower-lid contact surface, and an under-lid support structure and method steps and apparatus for implementing the same. In preferred embodiments, a translating multifocal lens with at least a portion of one surface may be Free-formed comprising one or both of a lower-lid contact surface and an under-lid support structure capable of limiting the amount of translation of a lens across a surface of an eye when an eye changes from one Optic Zone to another.

### CROSS REFERENCE TO RELATED APPLICATIONS

This application claims priority to the U.S. Provisional Application No. 61/617,794, filed Mar. 30, 2012, the contents of which are relied upon and incorporated herein.

### FIELD OF USE

This invention relates to contact lenses and more specifically, to a translating multifocal contact lens including multiple Optic Zones and one or both of an under-lid support structure and a lower-lid contact structure, wherein the structures aid in limiting lens movement upon an eye when an eye translates between the multiple Optic Zones.

### BACKGROUND OF THE INVENTION

Bifocal lenses are comprised of two or more areas, or zones, with different optical powers, including typically a far-power Optic Zone for distance vision, and a near-power Optic Zone for near or close up vision. The two zones may be subdivided into additional power zones in which case a lens may be called a multifocal lens. Previously known multifocal lenses have been limited by known manufacturing apparatus, such as, for example, cast molding, standard lathing or tooling technology, and injection molding technology.

The retinal image and the visual percept that results from it are dependent upon the light that enters an eye through the entrance pupil. In order for a bifocal contact lens to function properly, the entrance pupil must be covered at least partly or, more effectively, completely by the distance-power zone of a lens when an eye observes a distant object, and covered at least partly or, more effectively, completely by a near-power zone of a lens when an eye observes a near object. This function may be accomplished by the principle of alternating vision in which a shifting action or translation of a contact lens is made to occur in order to place one or the other zones in front of the entrance pupil as an eye alternates between viewing distance and near objects.

Alternatively, a principle known as simultaneous vision may be utilized whereby a lens is designed and fitted in such a way as to position part or all of both the far and near-power zones in front of the entrance pupil at the same time so that each contributes to the retinal image simultaneously. There is little or no translation required with this type of lens however, consequently two images are seen simultaneously, compromising vision.

Generally, the two types of conventional bifocal contact lenses are segmented and concentric. Segmented bifocal contact lenses or translating contact lenses, generally have two or more divided optical power zones. A far-power zone is usually the upper zone and a near-power zone is usually the lower zone. With such a translating lens, a far-power zone of a lens is in front of the entrance pupil of an eye in straight-ahead gaze, while in downward gaze, the add power or near-power zone of a lens is over the entrance pupil.

Concentric bifocal contact lenses generally have a central power zone and one or more annular power zones that function usually, but not always, by the simultaneous vision principle. It is recognized that these lenses do not provide good vision for both distance and near viewing, and are only worn successfully by those who are willing to accept less than optimal vision.

Effective use of a bifocal contact lens requires translation of an ocular system between vision surfaces when an eye changes from gazing at an object at a distance to gazing at a nearby object. Alternatively, there may be a desire to have a translating multifocal contact lens that may have one or more intermediate-power zones in addition to far- and near-power Optic Zones. Such a translating contact lens may have to have an ability to control and optimize the amount of movement of a lens when the pupil translates from distance vision, to intermediate vision, to near vision, or any combination thereof.

While there are many designs for soft translating contact lenses, soft contact lenses have difficulty translating across the surface of an eye when the visual direction of an eye changes from a straight-ahead gaze, to a downward gaze. In one prior art example, describes a soft bifocal contact lens that has an integrally formed bevel to aid translation of a lens. While other designs may have the capability to translate across the surface of an eye when the visual direction of an eye changes from a straight-ahead gaze, to a downward gaze, but are not very efficient at controlling movement of a lens during an eye's translation to a different visual direction. Another prior art example, describes a soft multifocal contact lens that has an integrally formed ramped ridge zone adjoining an outwardly extending latitudinal ridge that sits on an eyelid to aid in translation of a lens. The latitudinal ridge portion has a bump at each end, thereby increasing elevation height of the ends of the ridge compared to the elevation height in the middle. Another disadvantage of the prior art is discomfort when worn upon an eye.

Therefore, there is a need for a soft translating multi-focal contact lens that is capable of limiting the amount of translation across the surface of an eye when an eye changes position from distance vision to near vision, and provides wearers with improved comfort. There is also a need for a soft translating multi-focal contact lens that can limit the amount of translation across the surface of an eye when an eye changes position from distance vision, to intermediate vision, to near vision, and improves optical efficiency.

### SUMMARY

Accordingly, one aspect of this invention provides a translating multifocal contact lens resulting in limited lens translocation relative to the pupil of an eye. The limited translocation may be based upon one or both of vertical stability and rotational stability when using near, intermediate, and distance vision. In some embodiments of the present invention, components may include, for example, one or more of: an anterior surface, a posterior surface, an optical-power region, a Lens Edge, Stabilization Zones, a peripheral region, a center, an under-lid support structure, and a lower-lid contact surface. More specifically, the present invention discloses a translating multifocal contact lens including an under-lid support structure and a lower-lid contact surface. Free-form technology enables many previously unobtainable shapes and forms including non-spherical. The voxel by voxel formation essentially, allows for a great variety of shapes formable on a substrate.

### BRIEF DESCRIPTIONS OF DRAWINGS

FIG. 1A illustrates a front plan view of a translating multifocal contact Lens containing multiple features.

FIG. 1B illustrates a side view of anterior and posterior surfaces of a translating multifocal contact Lens.

FIGS. 2A-2D illustrate examples of multiple variations of Stabilization Zone location, and occurrence that are possible with the present invention.

FIGS. 3A-3H illustrate examples of multiple variations of different types, shapes, and arrangements of Optic Zones that may occur in an optical-power region.

FIG. 4 illustrates method steps according to some additional aspect of the present invention.

FIG. 5 illustrates a processor that may be used to implement some embodiments of the present invention.

### DETAILED DESCRIPTION OF INVENTION

The present invention provides for a translating multifocal contact lens including one or both of a lower-lid contact surface, and an under-lid support structure, in accordance with a particular patient's eye data and method steps and apparatus for implementing the same. A preferred embodiment of the present invention includes a Free-formed, translating multifocal contact lens, as is discussed more fully below in relation to the various figures.

In the following sections, detailed descriptions of embodiments of the invention are given. The description of both preferred and alternative embodiments though thorough are exemplary embodiments only, and it is understood to those skilled in the art that variations, modifications and alterations may be apparent. It is therefore to be understood that said exemplary embodiments do not limit the broadness of the aspects of the underlying invention. Method steps described herein are listed in a logical sequence in this discussion. However, this sequence in no way limits the order in which they may be implemented unless specifically stated. In addition, not all of the steps are required to implement the present invention and additional steps may be included in various embodiments of the present invention.

### GLOSSARY

In this description and claims directed to the presented invention, various terms may be used for which the following definitions will apply:

“Blend Zone” as used herein means a contiguous area that blends a portion of a lens to another adjoining portion of a lens.

“DMD Show” as used herein, refers to a collection of time based instructional data points that may be used to control activation of mirrors on a DMD, and enable a Lens or Lens Precursor or Lens Precursor Form or Lens Precursor Feature(s) to be fabricated. A DMD Show may have various formats, with (x, y, t), and (r, θ, t) being the most common where, for example “x” and “y” are Cartesian coordinate locations of DMD mirrors, “r” and “θ” are Polar coordinate locations of DMD mirrors, and “t” represents time instructions controlling DMD mirror states. DMD Shows may contain data associated with a regularly or irregularly spaced grid.

“Fluent Lens Reactive Media” as used herein means a Reactive Mixture that is flowable in either its native form, reacted form, or partially reacted form and, a portion or all Reactive Media may be formed upon further processing into a part of an ophthalmic lens.

“Free-form” as used herein “free-formed” or “free-form” refers to a surface that is formed by crosslinking of a Reactive Mixture via exposure to actinic radiation on a voxel by voxel basis, with or without a fluent media layer, and is not shaped according to a cast mold, lathe, or laser ablation. Detailed description of Free-form methods and apparatus are disclosed in U.S. patent application Ser. No. 12/194,981 (VTN5194USNP) and in U.S. patent application Ser. No. 12/195,132 (VTN5194USNP1) which are incorporated herein by reference

“Lens” as used herein “lens” refers to any ophthalmic device that resides in or on the eye. These devices may provide optical correction or may be cosmetic. For example, the term lens may refer to a contact lens, intraocular lens, overlay lens, ocular insert, optical insert or other similar device through which vision is corrected or modified, or through which eye physiology is cosmetically enhanced (e.g. iris color) without impeding vision. In some embodiments, the preferred lenses of the invention are soft contact lenses are made from silicone elastomers or hydrogels, which include but are not limited to silicone hydrogels, and fluorohydrogels.

“Lens Design” as used herein, refers to form, function or both of a desired Lens, which if fabricated, may provide optical power correction, acceptable Lens fit (e.g., corneal coverage and movement), acceptable Lens rotation stability, etc. Lens Designs may be represented in either a hydrated or un-hydrated state, in Flat or Curved Space, in 2-dimensional or 3-dimensional space, and by a method including but not limited to, geometric drawings, power profile, shape, features, thicknesses etc. Lens Designs may contain data associated with a regularly or irregularly spaced grid.

“Lens Edge” as used herein, refers to a feature to provide a well-defined edge around a perimeter of a Lens Precursor or a Lens that may contain Fluent Lens Reactive Media. A Lens Edge feature may be either continuous around a Lens Precursor or a Lens, or may be present in discrete, non-continuous zones.

“Lens Precursor” as used herein, means a composite object consisting of a Lens Precursor Form and Fluent Lens Reactive Media in contact with a Lens Precursor Form that may be rotationally symmetrical or non-rotationally symmetrical. For example, in some embodiments Fluent Lens Reactive Media may be formed in the course of producing a Lens Precursor Form within a volume of Reactive Mixture. Separating a Lens Precursor Form and Fluent Lens Reactive Media from a volume of Reactive Mixture used to produce a Lens Precursor Form may generate a Lens Precursor. Additionally, a Lens Precursor may be converted to a different entity by either the removal of an amount of Fluent Lens Reactive Media or the conversion of an amount of Fluent Lens Reactive Media into non-fluent incorporated material.

“Lens Precursor Feature”, also referred to as “feature”, as used herein, refers to a non-fluent substructure of a Lens Precursor Form, and acts as an infrastructure for a Lens Precursor. Lens Precursor Features may be defined empirically or described mathematically by control parameters (height, width, length, shape, location, etc.) may be are fabricated via DMD Show instructions. Examples of Lens Precursor Features may include one or more of the following: a Lens Edge feature, a Stabilization Zone feature, a Smart Floor Volumator feature, an Optic Zone feature, a Moat feature, a Drain Channel feature, etc. Lens Precursor Features may be fabricated using Actinic Radiation Voxels and may be incorporated into an ophthalmic Lens upon further processing.

“Minimal Energy Surface” as used herein, or the term “MES”, refers to a free-formed surface created by Fluent Lens Reactive Media formed over Lens Precursor Features, which may be in a minimum energy state. Minimal Energy Surfaces may be smooth and continuous surfaces.

“Optic Zone” as used herein, refers to a feature that provides one or both of a desired optical power and aberration correction of a Lens Precursor or ophthalmic Lens, the geometry of which may be directly dependent on a Target File.

“Reactive Mixture” as used herein, may be interchangeably used with “Lens Forming Mixture”; lens-forming monomer; refers to a monomer or prepolymer material which can be cured and/or crosslinked to form an ophthalmic lens or portion of an ophthalmic lens. Various embodiments can include lens-forming mixtures with one or more additives such as: UV blockers, tints, photoinitiators, or catalysts, and other additives one might desire in an ophthalmic lenses such as, contact or intraocular lenses.

“Stabilization Zone” as used herein, refers to a feature that may assist in keeping non-rotationally symmetric contact Lenses correctly oriented on an eye and may be found inboard of a Lens Edge feature and outboard of one or both of an optical-power region and an Optic Zone feature.

“Target File”, as used herein, refers to data that may represent a Lens Design, a Thickness Map, a Lens Precursor design, a Lens Precursor Form design, a Lens Precursor Feature design, or combinations of the above. A Target File may be represented in either a hydrated or un-hydrated state, in Flat or Curved Space, in 2-dimensional or 3-dimensional space, and by methods including but not limited to, geometric drawings, power profile, shape, features, thicknesses etc. Target Files may contain data associated with a regularly or irregularly spaced grid.

In some embodiments, physical features included in a lens may be functionally important to aid in lens comfort and fit when upon an eye, as well as corrected sight. Accordingly, a patient's eye measurement data may be obtained by utilizing various types of clinical vision equipment and may be used to influence parameters such as, for example, size, shape, amount, and location of physical features that may include a translating multifocal contact lens.

Additionally, physical features of a wearer's eye may be functionally important to aid in one or both of vertical stability and rotational stability by limiting movement of a lens when a pupil's line of sight moves from one Optic Zone to another Optic Zone. In some embodiments, a translating multifocal contact lens may include one or more of: an anterior surface, a posterior surface, a Lens Edge, a peripheral region, Stabilization Zones, an optical-power region, a center, an under-lid support structure, and a lower-lid contact surface.

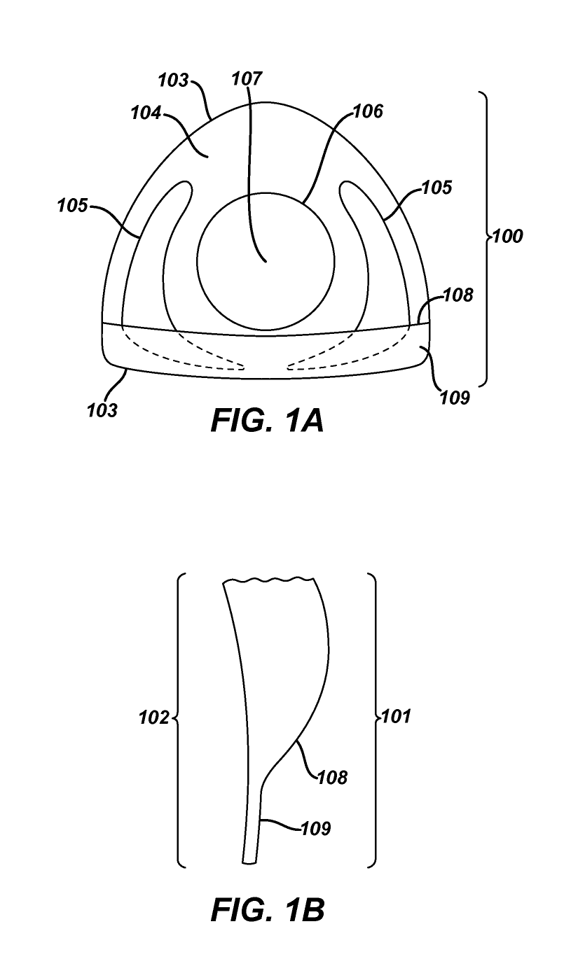

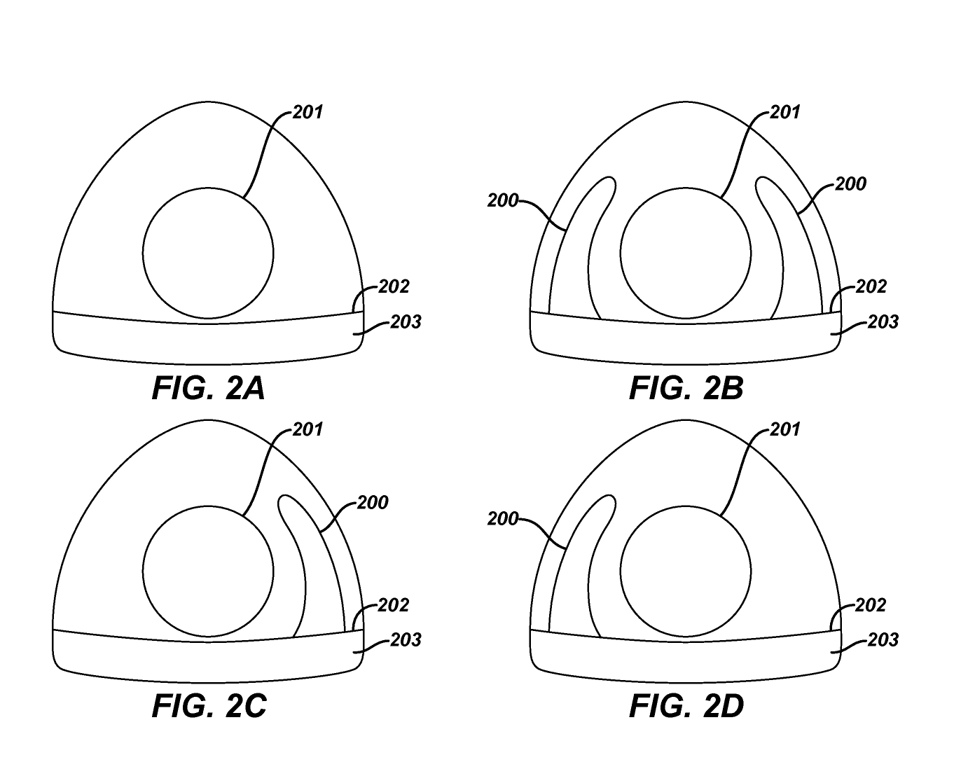

Referring now to FIGS. 1A and 1B, in FIG. 1A, a front plan view of an anterior surface 101 of a translating multifocal contact Lens 100 containing multiple features is illustrated. In FIG. 1B, a side view of an anterior surface 101 and a posterior surface 102 of a translating multifocal contact lens 100 is illustrated. In some embodiments, a contact lens 100 may include, for example, an anterior surface 101, a posterior surface 102, a Lens Edge 103, a peripheral region 104, Stabilization Zones 105, an optical-power region 106, a center 107, a lower-lid contact surface 108, and an under-lid support structure 109.

In some embodiments, an anterior surface 101 may include, for example, one or more of: an optical-power region 106, a peripheral region 104, and a Lens Edge 103. In some embodiments, a lens 100 may include a variety of round and non-round geometric hydrogel shapes formed as surface features into the anterior surface 101 for example, one or more of spherical, non-spherical, toroidal, and irregular hydrogel shapes rising from the anterior surface 101 of the lens.

Accordingly, an optical-power region 106 may include, for example, a variety of round and non-round geometric shapes and be centrally located, inside of a peripheral region 104 of a lens 100. A peripheral region 104 may extend radially from an outer edge of an optical-power region 106 to a Lens Edge 103. A Lens Edge 103 may extend radially from an outer edge of a peripheral region 104 to where an anterior surface 101 and a posterior surface 102 of a lens 100 meet each other and operates as a perimeter, as it goes around an entire circumference of a lens 100.

In some other preferred embodiments, an anterior surface 101 may include one or more of: a Stabilization Zone 105, a lower-lid contact surface 108, and an under-lid support structure 109. Incorporation of an under-lid support structure 109 and of a lower-lid contact surface 108 into a translating multifocal contact lens 100 may provide for a larger area of lower eyelid contact. The under-lid support structure 109 may also provide one or both of: vertical stability and rotational stability while wearing the multifocal contact lens 100.

In some embodiments, a Stabilization Zone 105 may be present on one or both sides of an optical-power region 106. The Stabilization Zone 105 may facilitate one or both of: vertical stability and rotational stability for the multifocal contactless 100. In addition, the Stabilization Zone 105, an under-lid support structure 109, and a lower-lid contact surface 108 may be contoured to aid in lens 100 comfort and lens 100 fit.

In another aspect, a posterior surface 102 may include a peripheral region 104, and an optical-power region 106 including one or more multiple Optic Zones. The peripheral region 104 and an optical-power region 106 may contribute to relevant powers of a contact lens 100. In some embodiments, a posterior surface 102 may include, for example, one or both of a peripheral region 104 and an optical-power region 106 including one or more of a far-power Optic Zone, an intermediate-power Optic Zone, and a near-power Optic Zone. In some additional embodiments, a posterior surface 102 may include, for example, one or both of a peripheral region 104, and an optical-power region 106 including one or both of a far-power Optic Zone and a near-power Optic Zone.

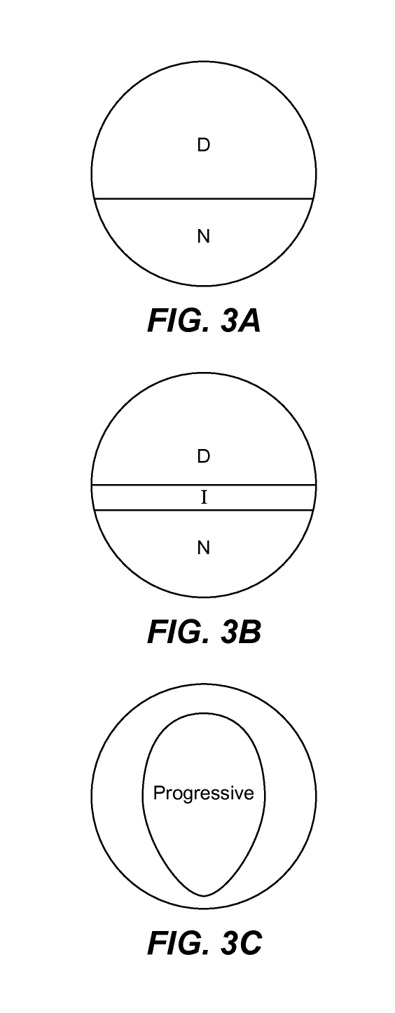

Referring now to FIGS. 2A-2D, illustrate examples of multiple variations of Stabilization Zone 200 location, and occurrence that may fall within the present invention. In some embodiments, a lens may include one or multiple Stabilization Zones 200 to provide for one or both of vertical stability and rotational stability when upon an eye. Furthermore, a Stabilization Zone 200 may include a variety of geometric shapes formed into the surface of the Stabilization Zone 200 and defined by one or both of points and lines with at least one curve to define a surface, which may also aid in improved wearer comfort. In some embodiments, for example, a lens 204C may include one Stabilization Zone 200C that may occur on one of either a right side of an optical-power region 201C, (as seen in FIG. 2C), or that may occur on a left side of an optical-power region 201D, (as seen in FIG. 2D).

In yet other embodiments, a lens 204A may not include a Stabilization Zone 200A (as seen in FIG. 2A), or a lens 204 B may include at least two or more Stabilization Zones 200B (as seen in FIG. 2B).

In some embodiments, Stabilization Zones 200B-D may include an arced segment of hydrogel material with an angular width of between about 0° to 180° that may extend from a top edge of an optical-power region 201 to a top edge of a lower-lid contact surface 202. In addition, a Stabilization Zone 200B-D may include a width (w) of about 5 mm or less that extends radially from a center of a Lens, and an axial peak height (ht) of 1 mm or less that extends vertically from a base of a Stabilization Zone 200B-D. In some preferred embodiments, a Stabilization Zone 200B-D may include an angular width of about 124°, a width of about 3 mm and a height of about 0.5 mm.

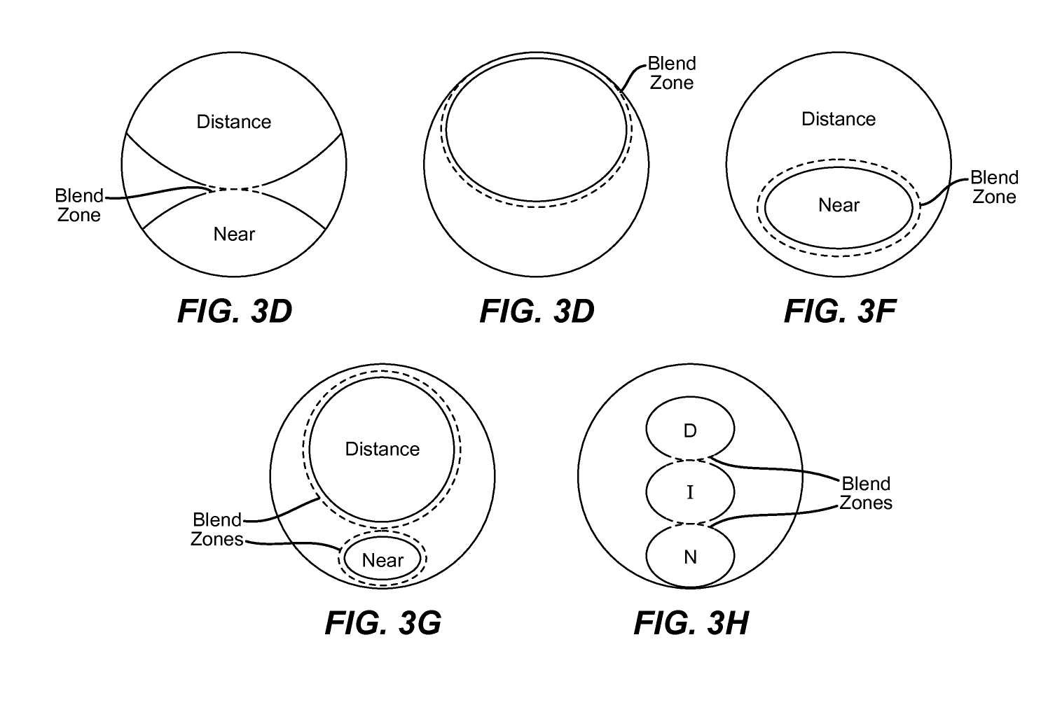

Referring now to FIGS. 3A-3H, illustrate examples of multiple variations of different types, shapes, and arrangements of Optic Zones that may occur within an optical-power region. An Optic Zone may include a variety of geometric shapes defined by one or both of points and lines with at least one curve to define a surface. In some embodiments an optical-power region may include multiple Optic Zones, such as, for example, one or more of a far-power Optic Zone for distance vision, an intermediate-power Optic Zone for intermediate vision, and a near-power Optic Zone for close-up or near vision. In some other embodiments, for example, a far-power Optic Zone, an intermediate-power Optic Zone, and a near-power Optic Zone may occur in descending order that may occur going from top to bottom of an optical-power region.

Some additional embodiments include, for example, Optic Zones that may occur as one or more of split-Optic Zones FIGS. 3A and 3B, progressive Optic Zones FIG. 3C, and blended Optic Zones FIGS. 3D-3H. In some embodiments, for example, a Blend Zone may include a contiguous area blending an Optic Zone FIGS. 3D-3H to another adjoining portion of a lens including one or more of an Optic Zone, a peripheral region, and a lower-lid contact surface. A progressive lens, as illustrated in FIG. 3C, includes multiple Optic Zones formed across a continuum, as opposed to discrete zones.

In another aspect of the present invention, a lower-lid contact surface may include a contiguous, inward extension of an anterior surface portion that extends laterally across an entire anterior lens surface thereby, providing a shelf-like structure that may rest on a lower eyelid. In some embodiments, a lower-lid contact surface may be located directly above an adjoining under-lid support structure. Furthermore, a lower-lid contact surface may include a variety of geometric shapes defined by one or both of points and lines with at least one curve to define a surface. Accordingly, in some embodiments, a lower-lid contact surface may be contoured to an exact shape of a patient's lower eyelid that may provide for one or more of a better fit, wearer comfort, vertical stability, rotational stability, and limiting an amount of lens translocation when a wearer changes line of sight from one Optic Zone to another.

Some additional embodiments include an under-lid support structure that may begin underneath and adjoin a bottom portion of a lower-lid contact surface, and extend to a lower Lens Edge. In preferred embodiments, an under-lid support structure may include a width (w) of 4 mm or less, preferably a width of 2.1 mm. Accordingly, an under-lid support structure may include an arcuate anterior surface essentially contoured to a surface of an eye. In some embodiments, an under-lid support structure may be contoured to a patient's eye that may provide for a larger surface area and may allow a lens to more readily wrap around a cornea. Furthermore, such an under-lid support structure may aid in one or more of improved wearer comfort, vertical stability, and rotational stability for a lens when upon an eye.

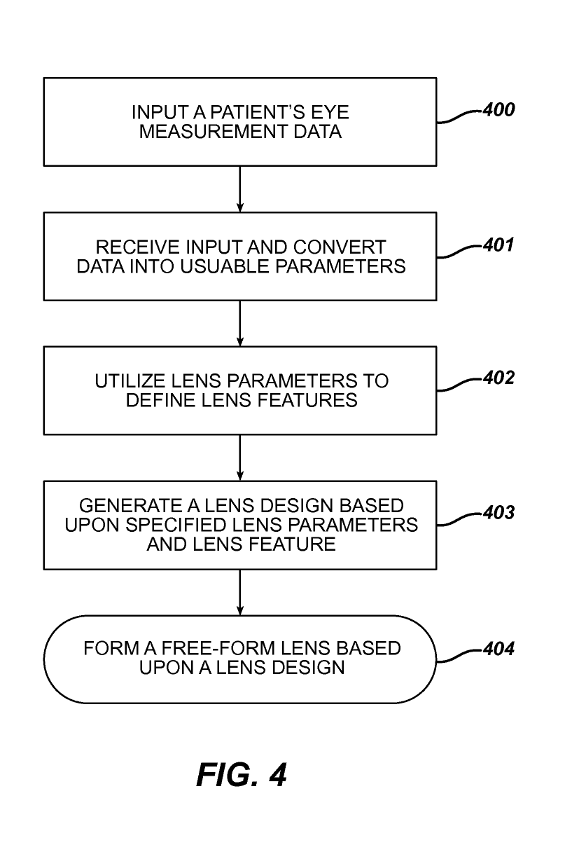

Alternatively, in some additional aspects of the present invention, referring now to FIG. 4, illustrates method steps that may be implemented to form a translating multifocal contact lens. In some embodiments, patient data may be used to implement formation of a translating multifocal contact lens. In one example, eye data may be obtained from various ocular measurement devices such as topographers, wavefront devices, microscopes, video cameras, etc., and the data subsequently stored in various embodiments. In another example, an eye may be examined in various lighting conditions, such as: low, intermediate, and bright lighting conditions, in which any data obtained, may be stored in various embodiments.

In some embodiments, different types of eye data obtained may include, for example, eye shape; lower-lid position relative to an upper-lid, a pupil, and a limbus; pupil, and limbus size, shape, and location at near viewing, intermediate viewing, and distance viewing; and lower-lid radius of curvature, and distance from pupil center. In one example, data obtained from a patient's eye may influence features of this invention such as, a shape of a Lens; shape, size, location, and amount of Stabilization Zones present; shape, size, location, and amount of Optic Zones present; and shape, size, and location of a lower-lid contact surface, and an under-lid support structure of a Lens.

At 400, a patient's eye measurement data may be input into various embodiments. At 401, once received, a patient's eye measurement data may be converted by algorithms into usable lens parameters. At 402, lens parameters may be utilized to define lens features included in a lens. At 403, a Lens Design may be generated based upon specified lens parameters and lens features. For exemplary purposes, a Lens Design of a lens surface may be based upon parameter data acquired from one or more ocular measurement devices applied to a patient's eye. In some embodiments, for example, size, shape, and location of an optical-power region of a Lens Design may be determined by a patient's pupil movement in various gaze directions. In some other embodiments, for example, shape and location of a lower-lid contact surface may be governed by a patient's lower-lid position and movement. At 404, a Free-form lens may be created based upon a generated Lens Design.

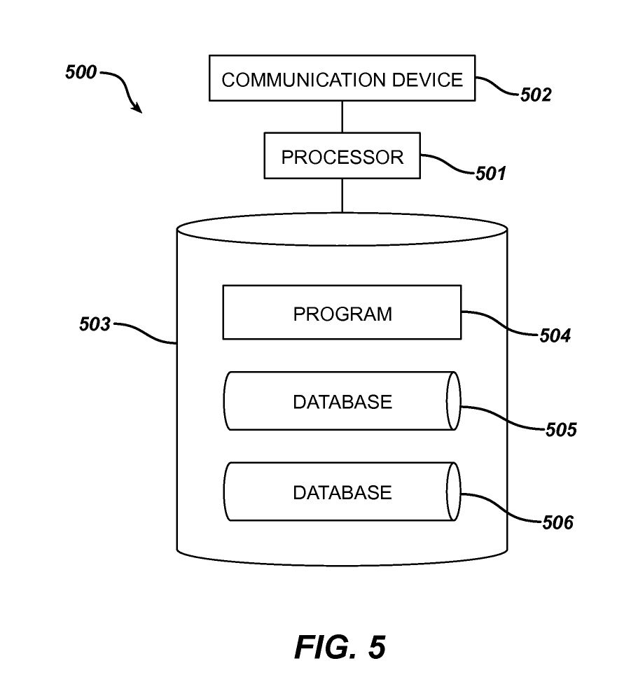

Referring now to FIG. 5, illustrates a controller 500 that may be used to implement some aspects of the present invention. A processor unit 501, which may include one or more processors, coupled to a communication device 502 configured to communicate via a communication network. The communication device 502 may be used to communicate, for example, with one or more controller apparatus or manufacturing equipment components.

A processor 501 may also be used in communication with a storage device 503. A storage device 503 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

A storage device 503 may store an executable software program 504 for controlling a processor 501. A processor 501 performs instructions of a software program 504, and thereby operates in accordance with the present invention such as, for example, the aforementioned method steps. For example, a processor 501 may receive information descriptive of a patient's eye data. A storage device 503 may also store ophthalmic related data in one or more databases 505 and 506. A database may include customized Lens Design data, metrology data, and defined lens parameter data for specific Lens Designs.

### CONCLUSION

The present invention, as described above and as further defined by the claims below, provides method steps of forming a Free-form translating multifocal contact lens and apparatus for implementing such methods, as well as the lenses formed thereby. In some embodiments, a Free-form translating multifocal contact lens may include one or both of an under-lid support structure, and a lower-lid contact surface.

What is claimed is:

1. An apparatus for forming a translating multifocal contact lens, the apparatus comprising:
a light source emanating light in a wavelength comprising actinic radiation;
a processor in logical communication with a memory wherein said memory stores executable code, executable upon demand to cause the processor to generate one or more control signals for controlling the digital mirror device to project the actinic radiation through an arcuate substrate to:
form a contact lens comprising an anterior surface and a posterior surface on a voxel by voxel basis, wherein said anterior surface and said posterior surface comprise respective arcuate shapes and meet at a Lens Edge;
form an optical-power region to provide vision correction for an eye of a user wherein said optical-power region comprises multiple Optic Zones;
form a lower-lid contact surface wherein the lower-lid contact surface limits the amount of said lens translocation upon the eye of the user when the user changes direction of vision and the user's line of sight moves from at least one Optic Zone to another said Optic Zone; and
form an under-lid support structure.

2. The apparatus of claim 1 wherein the lens comprises a Free-form lens.

3. The apparatus of claim 1 wherein the anterior surface comprises one or more of a peripheral region; a Stabilization Zone; and an optical-power region.

4. The apparatus of claim 3 wherein the Lens Edge extends radially from the outer edge of the peripheral region to where the anterior surface and the posterior surface meet each other.

5. The apparatus of claim 3 wherein the peripheral region extends radially from the outer edge of the optical-power region to the Lens Edge.

6. The apparatus of claim 3 wherein the lens comprises one or more Stabilization Zones present to provide for one or both of vertical stability for the lens and rotational stability for the lens.

7. The apparatus of claim 6 wherein the Stabilization Zone comprises a geometric shape defined by one or both of points and lines with at least one curve to define a surface.

8. The apparatus of claim 6 wherein the Stabilization Zone comprises an arced segment of hydrogel material with an angular width between 0° to 180°.

9. The apparatus of claim 6 wherein the Stabilization Zone comprises a width (w) of 5 mm or less, and a peak height (ht) of 1 mm or less.

10. The apparatus of claim 1 wherein the posterior surface comprises one or both of the peripheral region and the optical-power region.

11. The apparatus of claim 1 wherein the optical-power region comprises a spherical boundary shape.

12. The apparatus of claim 1 wherein the optical-power region comprises a non-spherical boundary shape.

13. The apparatus of claim 1 wherein the optical-power region comprises one or more of a far-power Optic Zone, an intermediate-power Optic Zone, and a near-power Optic Zone.

14. The apparatus of claim 13 wherein at least one said Optic Zone comprises a geometric shape defined by one or both of points and lines with at least one curve to define a surface.

15. The apparatus of claim 1 wherein the lower-lid contact surface comprises a contiguous, inward extension of the anterior surface portion that extends laterally across said anterior lens surface.

16. The apparatus of claim 15 wherein the lower-lid contact surface may be located directly above the adjoining under-lid support structure.

17. The apparatus of claim 15 wherein the lower-lid contact surface comprises a geometric shape defined by one or both of points and lines with at least one curve to define a surface.

18. The apparatus of claim 1 wherein the under-lid support structure adjoins the lower portion of the lower-lid contact surface and extends to a lower said Lens Edge.

19. The apparatus of claim 18 wherein the under-lid support structure comprises an arcuate anterior surface essentially contoured to the surface of the eye.

20. The apparatus of claim 18 wherein the under-lid support structure comprises a width of 4 mm or less.

21. The apparatus of claim 18 wherein the under-lid support structure provides for one or both of vertical stability for the lens and rotational stability for the lens.

22. A translating multifocal contact lens comprising:
an anterior surface wherein said anterior surface comprises an arcuate shape;
a posterior surface wherein said posterior surface comprises an arcuate shape, said posterior surface proximate to and opposite of said anterior surface, said posterior surface and said anterior surface meet each other at a Lens Edge;
an optical-power region to provide vision correction for an eye of a user wherein said optical-power region comprises multiple Optic Zones;
a lower-lid contact surface wherein the lower-lid contact surface limits the amount of said lens translocation upon the eye of the user when the user changes direction of vision and the user's line of sight moves from at least one Optic Zone to another said Optic Zone; and
an under-lid support structure.

23. The translating contact lens of claim 22 wherein the lens comprises a Free-form lens with a first portion formed on a voxel by voxel basis and a second portion formed from a fluent media.

24. The translating contact lens of claim 22 wherein the anterior surface comprises one or more of: a peripheral region and a Stabilization Zone.

25. The method of claim 24 wherein the Lens Edge extends radially from the outer edge of the peripheral region to where the anterior surface and the posterior surface meet each other.

26. The translating contact lens of claim 24 wherein the peripheral region extends radially from the outer edge of the optical-power region to the Lens Edge.

27. The translating contact lens of claim 24 wherein the lens comprises one or more Stabilization Zones present to provide for one or both of vertical stability for the lens and rotational stability for the lens.

28. The translating contact lens of claim 27 wherein the Stabilization Zone comprises a geometric shape defined by one or both of points and lines with at least one curve to define a surface.

29. The translating contact lens of claim 27 wherein the Stabilization Zone comprises an arced segment of hydrogel material with an angular width between 0° to 180°.

30. The translating contact lens of claim 27 wherein the Stabilization Zone comprises a width (w) of 5 mm or less, and a peak height (ht) of 1 mm or less.

31. The translating contact lens of claim 22 wherein the posterior surface comprises one or both of the peripheral region and the optical-power region.

32. The translating contact lens of claim 22 wherein the optical-power region comprises a spherical boundary shape.

33. The translating contact lens of claim 22 wherein the optical-power region comprises a non-spherical boundary shape.

34. The translating contact lens of claim 22 wherein the optical-power region comprises one or more of a far-power Optic Zone, an intermediate-power Optic Zone, and a near-power Optic Zone.

35. The translating contact lens of claim 34 wherein at least one said Optic Zone comprises a geometric shape defined by one or both of points and lines with at least one curve to define a surface.

36. The translating contact lens of claim 22 wherein the lower-lid contact surface comprises a contiguous, inward extension of the anterior surface portion that extends laterally across said anterior lens surface.

37. The translating contact lens of claim 36 wherein the lower-lid contact surface may be located directly above the adjoining under-lid support structure.

38. The translating contact lens of claim 36 wherein the lower-lid contact surface comprises a geometric shape defined by hydrogel formed into surface features with one or both of: points and lines and at least one curve to define a surface.

39. The translating contact lens of claim 22 wherein the under-lid support structure adjoins the lower portion of the lower-lid contact surface and extends to a lower said Lens Edge.

40. The translating contact lens of claim 39 wherein the under-lid support structure comprises an arcuate anterior surface essentially contoured to the surface of the eye.

41. The translating contact lens of claim 39 wherein the under-lid support structure comprises a width of 4 mm or less.

42. The translating contact lens of claim 39 wherein the under-lid support structure provides for one or both of vertical stability for the lens and rotational stability for the lens.
